(19) United States
(12) Patent Application Publication
(10) Pub. No.: US 2022/0388818 A1
(43) Pub. Date: Dec. 8, 2022

(54) WINCH FOR HANDLING, IN PARTICULAR FOR LIFTING, A LOAD

(71) Applicant: SAPELEM, BEAUCOUZE (FR)

(72) Inventor: Pascal DENOEL, PARIS (FR)

(21) Appl. No.: 17/769,741

(22) PCT Filed: Oct. 14, 2020
(86) PCT No.: PCT/FR2020/051811

§ 371 Date: Apr. 16, 2022

(30) Foreign Application Priority Data
Oct. 17, 2019 (FR) FR1911585

(51) Int. Cl. B66D 1/24; B66D 1/50; B66D 1/12

(52) U.S. Cl. CPC B66D 1/24; B66D 1/505; B66D 1/12; B66D 2700/0141

(57) ABSTRACT

Winch (1) comprising a drum (2), a cable (6) which can be wound around the drum (2), means (7) for fastening the load (20) to the cable (6), a motor (3) with a motor shaft (4), a control (17) for the motor (3) that drives the motor shaft (4) to rotate in two opposite directions, and mechanical transmission means (5) for transmitting the rotational movement of the motor shaft (4) to the drum (2), said means (5) being configured so as to allow, in the state in which the motor shaft (4) is driven to rotate in a first direction D1, the transmission of the rotational movement of the motor shaft (4) to the drum (2) in the direction of winding the cable (6) around the drum (2). In the state in which the motor shaft (4) is driven to rotate in the second direction D2, the mechanical movement transmission means (5) are configured so as to not allow the transmission of the rotational movement of the motor shaft (4) to the drum (2), and at least part of these mechanical means (5) is configured to form, in this second operating mode, a brake preventing the drum (2) from being driven to rotate.

The present invention relates to a winch for handling, in particular for lifting, a load.

It relates more particularly to a winch comprising a drum, a cable that can be wound around the drum, means for attaching the load to the cable, a motor equipped with a drive shaft, a motor controller configured to selectively control the motor according to two operating modes, namely a first operating mode in which the drive shaft of the motor is able to be driven in rotation in a first direction, and a second operating mode in which the drive shaft of the motor is able to be driven in rotation in a second direction opposite to the first direction.

Such winches are known. Until now, the drum has been designed to rotate as one with the drive shaft on the one hand, when it is driven in rotation in the direction of winding of the cable around the drum, on the other hand, when it is driven in rotation in the direction of unwinding the cable from the drum. As a result, during this phase of unwinding the cable from the drum, it is possible for the tension on the cable to become relaxed, called “slack” on the cable. This relaxation of the tension, or “slack”, on the cable occurs when a command to unwind the cable is given when the load has already been set down. Such slack in the cable can cause a loop in the cable at the point where the cable attaches to the drum. When rewinding the cable (raising order), the loop formed in this way can become jammed between the drum and the cable casing. This jamming generally results in damage to the cable, requiring its immediate replacement. The major problem with this situation is that it is not necessarily detected when it appears. The operator can therefore unwittingly use a winch with a damaged cable. The danger to the operator is then significant. In addition, in the case where a load is attached to the cable and the cable has “slack” or relaxation at the drum exit, at the time of the order to rewind the cable with a view to raising a load, the beginning of the cable rewinding run takes up the “slack” on the cable. When the cable comes under tension, the relatively high winding speed causes a jolt to the winch. Repeated jolts to the winch increases fatigue in the winch, and means that the winch has to be sized so as to take into account an equivalent overload. Taking jolts into account therefore means that the winch has to be oversized, which generally leads to making it heavier.

Solutions to prevent the appearance of such cable relaxation, once the load has been set down, do exist, but these solutions are generally complex and therefore expensive and difficult to implement.

Solutions in which the cable is unwound automatically and then manually are known. These solutions require that the operator exert a pulling force on the object to be handled in order to take it to the desired location, as illustrated in patent EP-2,865,633. Other solutions are described in patents U.S. Pat. Nos. 2,958,509 and 5,848,781.

To that end, the invention relates to a winch for handling a load, said winch comprising a drum, a cable that can be wound around the drum, means for attaching the load to the cable, a motor equipped with a drive shaft, a controller for the motor configured to selectively control the motor according to two operating modes, namely a first operating mode, in which the drive shaft of the motor is capable of being driven in rotation in a first direction, and a second operating mode, in which the drive shaft of the motor is capable of being driven in rotation in a second direction opposite to the first direction, and mechanical means for transmitting the rotational movement of the drive shaft to the drum, the mechanical movement transmission means arranged between the drive shaft and the drum being configured to allow, in the first operating mode, termed load lifting, when the drive shaft is driven in rotation in the first direction, the transmission of the rotational movement of the drive shaft to the drum in order to drive said drum in rotation so as to wind the cable around the drum, characterized in that, in the second operating mode, termed load lowering, when the drive shaft is driven in rotation in the second direction, the mechanical movement transmission means are configured so as not to allow the transmission of the rotational movement of the drive shaft to the drum, at least part of the mechanical movement transmission means being configured to form, in this second operating mode, a brake on the rotational driving of the drum, limiting or preventing the rotational driving of the drum in the direction of unwinding of the cable from the drum under the action of a tensile force exerted on the cable, in particular by a load suspended from said cable.

The fact that the drum is not driven in rotation by the drive shaft when the drive shaft is driven in rotation in the direction of unwinding of the cable from the drum makes it possible to use the load as a driving element for the unwinding of the cable from the drum and thus avoid the appearance of relaxation or “slack” in the cable when the load attached to the cable is set down. The use of part of the mechanical movement transmission means as an element forming a brake for the drum, when the drum is driven in rotation in the direction of unwinding of the cable from the drum, makes it possible to reinforce the use of the load as a driving element when the drum is driven in rotation in the direction of unwinding of the cable from the drum.

According to one embodiment of the invention, the mechanical movement transmission means comprise an overrunning clutch, preferably chosen from the group consisting of ratchet-, cam-, ball- or roller-type overrunning clutches, this clutch being interposed between the drive shaft and the drum.

The use of an overrunning clutch between the drum and the drive shaft makes it possible, when the drive shaft is driven in rotation in a manner corresponding to the drum being driven in rotation in the direction of a winding of the cable around the drum, for the rotational movement of the drive shaft to be transmitted to the drum while this transmission of movement does not take place, owing to the overrunning operation of said clutch, when the drive shaft is driven in rotation in a second direction opposite to the first direction and corresponding to the instruction to drive the drum in rotation in the direction of unwinding of the cable from the drum to allow the load to form the driving element of the unwinding of the cable.

According to one embodiment of the invention, the overrunning clutch comprises two rotating coaxial parts, one referred to as the outer, the other the inner, and elements such as rollers, balls, cams, or pawls arranged in a space left free between said parts, said parts being mounted such that one rotates as one with the drive shaft and the other rotates as one with the drum, and the elements being loaded individually by a spring, the part that rotates as one with the drive shaft forming, in cooperation with the elements when said part rotating as one with the drive shaft is stationary, or in the second operating mode, when said part that rotates as one with the drive shaft is driven in rotation in the second direction, a means for limiting the angular displacement of the part that rotates as one with the drum which can be driven in rotation under the action of a tensile force exerted on the cable in the direction of unwinding of the cable from the drum and, in the first operating mode, when the drive shaft is driven in rotation in the first direction, a driving member for driving in rotation the part secured to the drum. The overrunning clutch therefore comprises two parts, namely two rotary coaxial rings and elements interposed between said rings. The ring that rotates as one with the drive shaft is capable of forming, in cooperation with elements such as rollers or cams interposed between the rings, when the ring that rotates as one with the drive shaft is driven in rotation in the first direction, a drive member for driving in rotation the ring that rotates as one with the drum and, when the ring that rotates as one with the drive shaft is driven in rotation in the second direction, a member for limiting the rotational displacement of the ring that rotates as one with the drum, this limiting member preventing the ring that rotates as one with the drum being driven in rotation, being able to be driven in rotation under the action of a tensile force exerted on the cable in the direction of unwinding of the cable, at a rotational speed greater than that of the rotational speed of the ring that rotates as one with the drive shaft.

According to one embodiment of the invention, the part that rotates as one with the drum forms the inner part of the overrunning clutch, this part that rotates as one with the drum being mounted on an axial extension of the drum.

According to one embodiment of the invention, the part that rotates as one with the drive shaft is coupled to the drive shaft by a reduction gear mechanism.

According to one embodiment of the invention, the drum is mounted so as to be able to move between a so-called maximum winding position, of the cable around the drum, and a so-called minimum winding position, also termed the position of being unwound from the drum, and the winch comprises means for returning the drum that are configured to allow a return force to be exerted on the drum, in a direction corresponding to the drum being driven in rotation in the direction of a winding of the cable around the drum. These return means comprise at least one spring. These return means have the advantage of ensuring a minimum tension in the lifting cable, and thus of eliminating the “slack”. Even when the load is set down on a surface at a high unwinding speed and the cable forms a slight “slack”, by the effect of inertia, the return means then immediately re-tauten the cable so that the residual tension in the cable is at least equal to the tension exerted by said return means, thus eliminating the “slack”.

According to one embodiment of the invention, the return means are configured to allow an adjustable return force to be exerted. The return force can be adjusted using a manually or automatically actuated adjusting member.

According to one embodiment of the invention, at least part of the controller for the motor is borne by the cable, and the return force of the return means is between the value of the force required to return the drum to the position of maximum winding of the cable around the drum in the bare state of the cable, that is to say devoid of motor controller, and the value of the force required to allow the drum to be driven in rotation in the direction of winding of the cable around the drum when at least a part of the controller for the motor is borne by the cable.

According to one embodiment of the invention, the drum is a grooved drum provided with an outer peripheral helical groove, and the winch comprises means for holding the cable inside the groove, these holding means comprising a cable guide provided with a passage for the cable, this cable guide being mounted so as to be axially movable and rotationally fixed along a guide path parallel to the axis of rotation of the drum, this cable guide being provided with a male element, such as a rib, inserted in the groove of the drum to allow, in parallel with the rotational drive of the drum, an axial displacement of the cable guide along the guide path.

According to one embodiment of the invention, when the winch is in the use configuration with the axis of rotation of the drum in a horizontal position, the male element of the cable guide is arranged facing a groove part of the drum that has no cable.

According to one embodiment of the invention, the means for holding the cable inside the groove of the drum further comprise a casing positioned around the drum over at least part of the circumference of the drum.

According to one embodiment of the invention, the winch whose drum is a grooved drum provided with an outer peripheral helical groove comprises an assembly for detecting the end of the winding run of the cable and an assembly for detecting the end of the unwinding run of the cable, each detection assembly comprising a magnetizable metallic conductor, such as a plate, and a—preferably inductive—sensor for detecting the presence of said metallic conductor, the sensor and the conductor can be positioned with one on a part mounted so as to be axially movable and fixed in rotation along a guide path parallel to the axis of rotation of the drum, this part being provided with a male element, such as a finger, inserted into the groove of the drum to allow, in parallel with the rotational driving of the drum, an axial displacement of said part along the guide path, and with the other in a stationary location, an end of run being detected when the metallic conductor enters or leaves the detection field of the sensor. This thus results in the possibility of easily detecting the position of the winding to avoid exceeding the maximum or minimum winding limit.

### BRIEF DESCRIPTION OF THE DRAWINGS

The invention will be clearly understood on reading the following description of exemplary embodiments, with reference to the appended drawings, in which:

FIG. 1 shows a schematic overall view of a winch according to the invention;

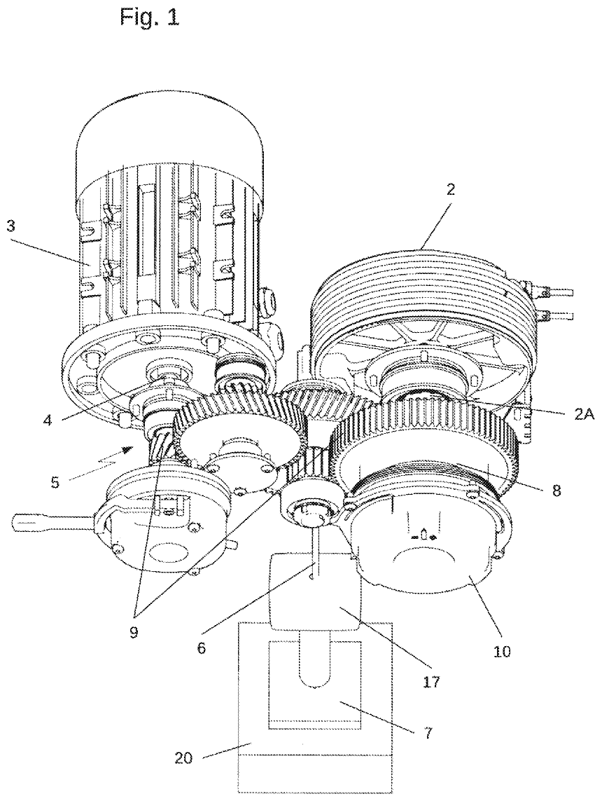

FIG. 2 shows a simplified schematic view of the drum equipped with its load lifting cable and its control member;

FIG. 3 shows a simplified sectional view of the mechanical means for transmitting movement between the drive shaft and the drum, the overrunning clutch of said movement transmitting means being a roller- or ball-type clutch;

FIG. 4 shows a simplified sectional view of the mechanical means for transmitting movement between the drive wheel and the drum, the overrunning clutch of said movement transmitting means being a cam-type clutch;

FIG. 5 shows a partial perspective view of a winch according to the invention;

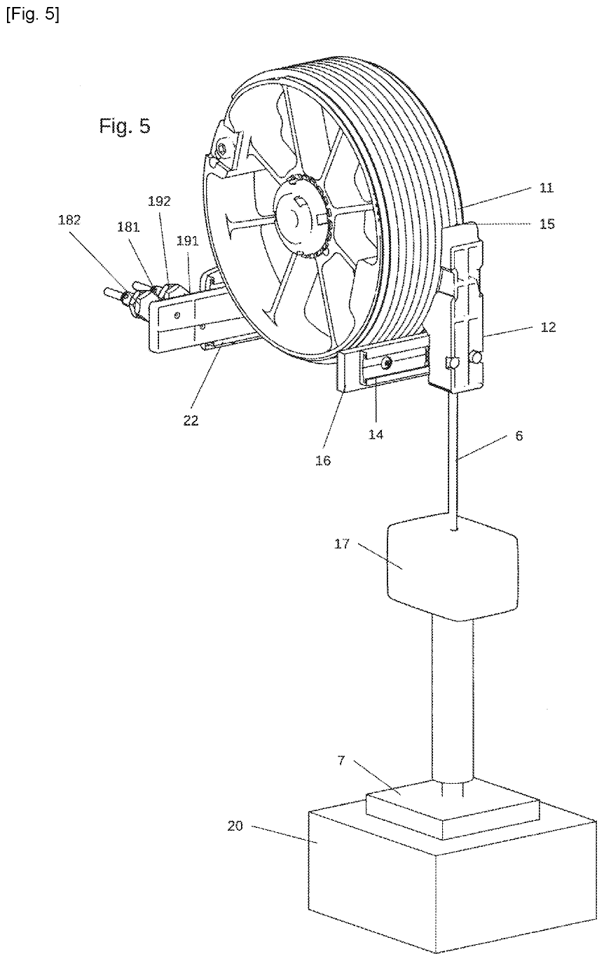

FIG. 6 shows a partial perspective view of a winch according to the invention;

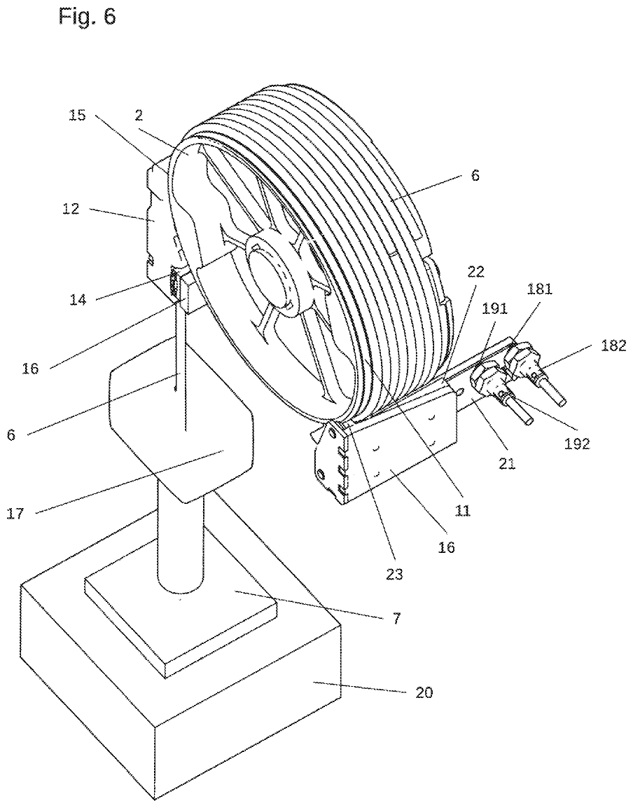

FIG. 7 shows a simplified schematic front view of a drum and its cable guide;

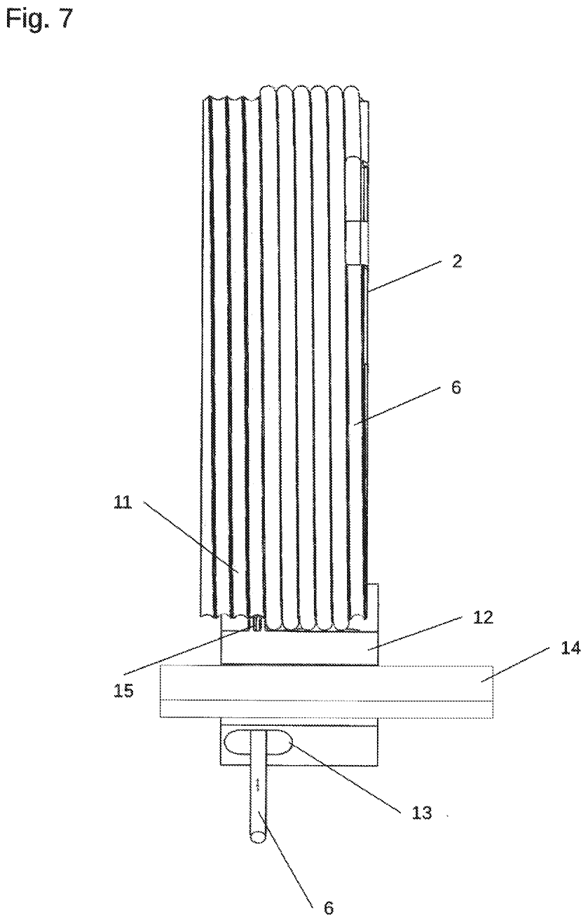

FIG. 8 shows a partial view of a winch, taken from below.

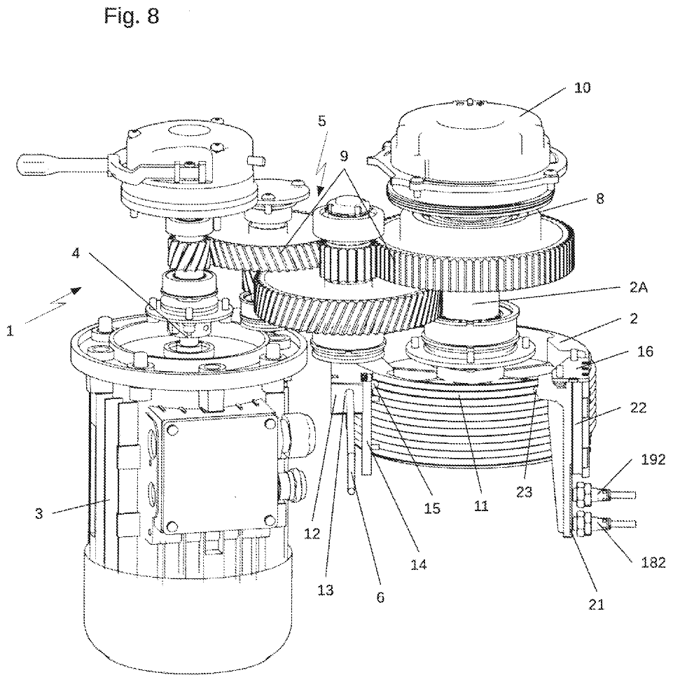

As mentioned above, the winch 1, to which the invention relates, allows the handling of a load 20, in particular the raising and lowering of a load 20. This winch 1 comprises, in a manner known per se, a drum 2 and a cable 6 that can be wound around the drum 2. In the example shown, the drum 2 is an externally grooved drum. The groove 11 is an outer peripheral helical groove. The cable 6 is placed in said groove 11. This cable 6 is equipped, at or near its free end, with means 7 for attaching the load 20, the other end being attached to said drum. These attaching means 7 can consist of a simple hook, vacuum gripping means such as a suction cup, or any other attaching means without departing from the scope of the invention.

The winch 1 further comprises a motor 3 fitted at its output with a drive shaft 4. This motor 3 is controlled using a controller 17, part of which is, in the examples shown, borne by the cable 6. This motor controller 17 comprises for example a handle mounted on the cable 6. This handle comprises two parts that move relative to each other to occupy at least two positions, allowing one to control the motor according to a first operating mode, called load lifting, in which the drive shaft 4 of the motor 3 is able to be driven in rotation in a first direction D1, the other, to control the motor according to a second operating mode, called load lowering, in which the drive shaft 4 of the motor 3 is able to be driven in a second direction D2 counter to the first direction D1. These two operating modes can be activated selectively. The winch is equipped with a motor control unit 3 which, based on the order received from the controller 17, drives the motor 3 in operation according to one or other of the operating modes described above, the first operating mode allowing, by winding the cable around the drum 2, the raising of the load, while the second operating mode allows, by unwinding the cable from the drum, the lowering of the load.

The winch 1 also comprises mechanical means 5 for transmitting the rotational movement of the drive shaft 4 to the drum 2. These mechanical transmission means 5 comprise, in the example shown, from the drive shaft 4 to the drum 2, a reduction gear mechanism 9 and an overrunning clutch 8. This configuration of the mechanical movement transmission means 5 allows, in the first operating mode, the transmission of the movement from the drive shaft 4 to the drum. Conversely, in the second operating mode, in which the drive shaft 4 of the motor 3 is capable of being rotated in the second direction D2 opposite to the first direction D1, owing to the presence of the overrunning clutch 8 that is capable of overrunning, the means 5 for transmitting movement are configured to not allow the transmission of the rotational movement of the drive shaft 4 to the drum 2. In this operating mode, at least part of the mechanical movement transmission means 5 are configured to form a brake on the rotational drive of the drum 2, limiting or preventing the drum 2 being driven in rotation in the direction of an unwinding of the cable 6 from the drum 2 under the action of a tensile force exerted on the cable 6, in particular by a load 20 that is suspended from said cable 6. In this second operating mode, it is no longer the drive shaft 4 which acts on the drum 2 to drive its rotational movement but the load 20 attached to the cable 6. The weight of this load 20 results in a tensile force on the cable 6. This tensile force drives the drum 2 in rotation in the direction of unwinding of the cable 6. In this second operating mode, owing to the presence of the overrunning clutch 8, the drive shaft can rotate without transmitting its rotational movement to the drum 2. Therefore, once the load is set down, even if the operator actuates the controller 17 to instruct an additional movement of the drum in the direction of unwinding of the cable, as the set-down load can no longer act as a driver, no unwinding of the cable takes place, despite the drive shaft 4 being driven in rotation. The cable 6 can thus remain taut.

To allow such operation, the overrunning clutch 8, which can be of any type, namely in particular an overrunning clutch 8 of the ratchet, cam, ball, roller or other type, comprises two coaxial rotary parts 81, 82, one referred to as the outer, the other as the inner. The outer part 81 and the inner part 82 are mounted so that one rotates as one with the drive shaft and the other rotates as one with the drum 2.

In the examples shown, parts 81 and 82 are rings, with part 82 rotating as one with the drum 2 which forms the inner ring or part of the overrunning clutch 8, and part 81 rotating as one with the drive shaft 4 which forms the outer ring or part of the overrunning clutch 8. The overrunning clutch 8 is mounted on an axial extension 2A of the drum 2. In particular, the inner part 82 of the overrunning clutch, which rotates as one with the drum, is mounted on an axial extension 2A of the drum 2, that is to say a shaft section which passes through the center of the drum and projects axially therefrom. Thus, the overrunning clutch 8 is offset laterally from the drum 2. The outer part 81 of the overrunning clutch 8 meshes with one of the pinions which form the reduction gear mechanism 9 arranged between the overrunning clutch 8 and the drive shaft 4. Therefore, this pinion itself meshes with a succession of pinions interposed between the pinion and the drive wheel 4. The overrunning clutch 8 comprises, in addition to the rotating coaxial parts 81, 82, elements arranged in a space left free between said parts. This space is an annular space when the parts are rings, as in the example shown. These elements shown at 83A and 83B in the figures can be of different natures depending on the type of overrunning clutch. These elements can thus consist of rollers, balls, cams, pawls or others. Regardless of their design, these elements are individually spring loaded 84. These elements are, in a manner known per se, mounted so as to be able to move and have, depending on the relative position, the rotary speed and the direction of relative displacement in rotation of the parts 81 and 82, two operating phases, namely a phase of blocking in the case, for example, of jamming-type overrunning clutches as in the example shown, where the elements jam without slipping between said parts 81 and 82 and a phase, called overrunning, in which part 81 can rotate freely without driving part 82 in rotation, this overrunning phase, in which the outer part 81 can rotate freely over at least one revolution without driving the inner part 82 in rotation, can only occur in the second operating mode.

The springs 84 fitted to the elements tend to return the elements to a position corresponding to the blocking phase. Independently of the nature of the elements, the part 81 which rotates as one with the drive wheel 4 forms, in the stationary state of said part 81 or, in the second operating mode, when said part 81 is driven in rotation in the second direction D2, a means for limiting the angular displacement of the part 82 which rotates as one with the drum 2 capable of being driven in rotation under the action of a tensile force exerted on the cable 6 in the direction of unwinding of the cable 6 from the drum 2 while, in the first operating mode, when the drive shaft 4 is driven in rotation in the first direction D1, this same part 81, which rotates as one with the drive shaft 4, forms with the elements 83A or 83B a drive member for driving in rotation the part 82 secured to the drum.

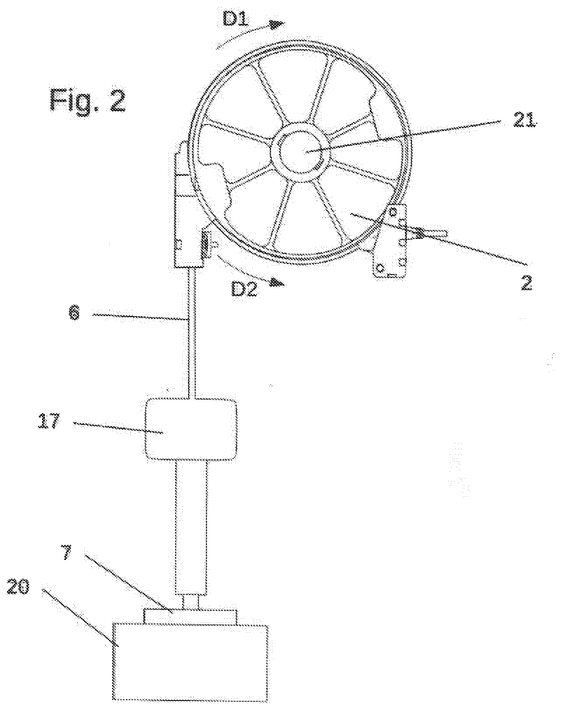

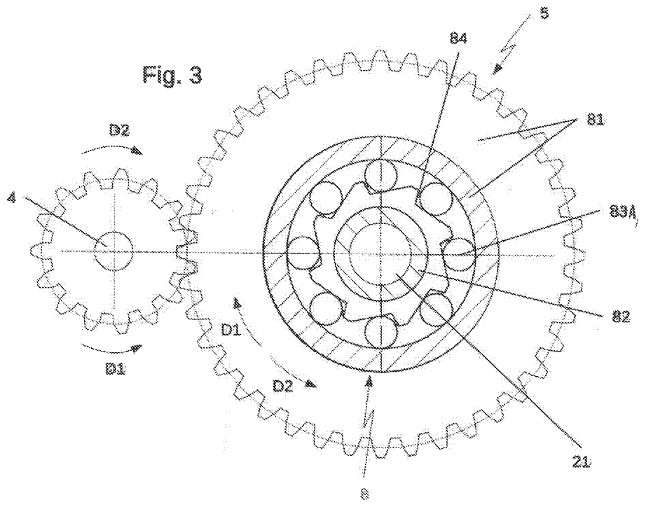

In the example shown in FIG. 3, which illustrates a roller-type overrunning clutch, the track of the outer ring 81 which rotates as one with the shaft is a cylindrical track while the track of the inner ring 82 which rotates as one with the shaft is a track fitted with blocking ramps. Thus, in the example of FIG. 3, when the part 81 is driven in rotation along D1, it causes by friction a relative movement of the rollers to a blocking position of the rollers between the track of the outer ring and the ramps of the track of the inner part, which drives the interior part 82—and consequently the drum 2—in rotation. This corresponds to the first operating mode, called raising of the load, the rotational drive of the drum taking place in a direction corresponding to the winding of the cable around the drum 2 as illustrated in FIG. 2.

In the second operating mode, when the outer part 81, which rotates as one with the drive shaft 4, is rotated in the direction D2 by the drive shaft 4, it can rotate freely with respect to the inner part 82 if part 82 is stationary, for example, this situation occurring once the load is set down. If the load has not yet been set down, the load exerts an action on the cable, which causes the drum —and consequently the intermediate part 82—to rotate in the second direction D2. This rotational drive can be limited by the outer part 81 when the outer part 81 rotates at a lower speed than the inner part 82. Indeed, this speed differential causes a relative rotational movement of the parts 81 and 82, which leads to a position where the part 82 is forced to rotate at a speed equal to that of the part 81 which acts as a brake. Similarly, when the outer part 81 is not driven in rotation, the rotational drive of the inner part 82 in the second direction D2 is prevented. The outer part 81 therefore plays, in connection with the elements, in the second operating mode or in the stationary position of said part, the role of a brake preventing or limiting the rotational drive of the part 82 and consequently, the rotational drive of the drum in the direction of unwinding of the cable from the drum.

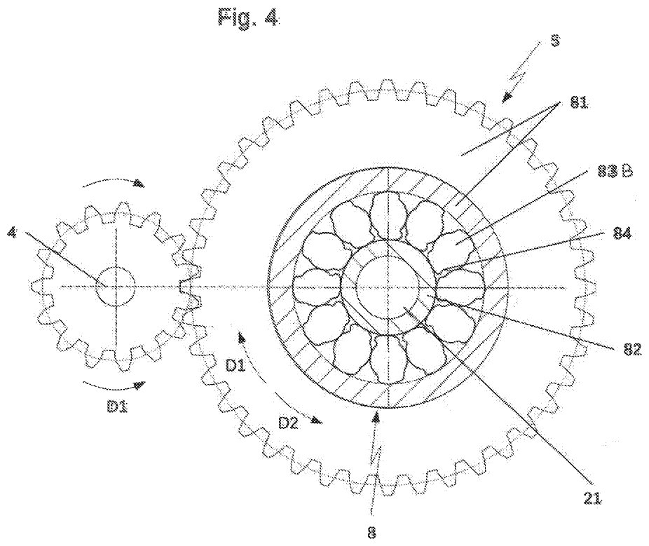

FIG. 4 illustrates a cam-type clutch with similar operation. In this case, the tracks of the inner and outer parts are cylindrical and the blocking phase takes place when the cams occupy a particular position in the space between the parts. This position is obtained following a relative rotational displacement of the parts between them, generating friction on the elements. Equivalent operation could have been obtained with a pawl-type clutch with ratchet teeth, the teeth being borne by one of the parts and the pawls by the other part.

To perfect the operation of this overrunning clutch, there are provided drum return means 10 that are configured to allow, in the second operating mode when the drive shaft 4—and consequently the drum 2—are driven in rotation in a second direction D2, a return force to be exerted on the drum 2. Indeed, the drum is mounted so as to be able to move between a so-called maximum winding position, of the cable 6 around the drum 2, and a so-called minimum winding position, also called position of maximum unwinding of the cable 6 from the drum 2. The return means 10 for the drum 2 are therefore configured to allow a return force to be exerted on the drum 2 in a direction corresponding to a rotational drive of the drum 2 in the direction of a winding of the cable 6 around the drum 2. These return means act in the second operating mode when the drum 2 is driven in rotation in the second direction D2.

In the examples shown, these return means 10 are configured to allow an adjustable return force to be exerted. This return force can be adjustable manually or using an actuator. Generally, these return means 10 comprise a spring which can be preloaded to a greater or lesser degree. This spring is for example a coil spring which is coaxial with the axis of rotation of the drum, and of which one end is fixed to the drum and the other end is in a stationary location. The rotation of the drum in the direction of unwinding of the cable causes compression of the spring, which tends to return the drum in rotation in the direction of winding of the cable around the drum. The presence of such a spring makes it possible to ensure a minimum tension in the lifting cable, and thus of eliminating the “slack”. Even when the load is set down on a surface at a high unwinding speed and the cable forms a slight “slack”, by the effect of inertia, the return means then immediately re-tauten the cable so that the residual tension in the cable is at least equal to the tension exerted by said return means, thus eliminating the “slack”.

The return force of the return means is between the value of the force required to return the drum 2 to the position of maximum winding of the cable 6 around the drum 2 in the bare state of the cable 6, that is to say devoid of controller 17 for the motor, and the value of the force required to allow the drum 2 to be driven in rotation in the direction of winding of the cable around the drum 2 when at least a part of the controller 17 for the motor 3 is borne by the cable 6. This avoids a displacement of the cable under the effect of the return means in the absence of a load.

To avoid a loop forming in the cable, the winch further comprises means 12, 16 for holding the cable 6 in the groove 11. These holding means 12, 16 comprise a cable guide 12 provided with a cable passage 13 which in this case is formed by a through-hole created in the cable guide 12. This cable guide 12 is mounted so as to be axially mobile and fixed in rotation along a guide path 14 parallel to the axis of rotation of the drum 2. This guide path 14 may consist of a rail. To allow such axial displacement, the cable guide 12 is provided with a male element 15, in this case a rib which is inserted into the groove 11 of the drum 2 to allow, in parallel with the rotational driving of the drum 2, an axial displacement of the cable guide 12 along the guide path 14. When the winch 1 is in the use configuration with the axis of rotation of the drum 2 in the horizontal position, this male element 15 of the cable guide 12 is arranged facing a part of the groove 11 of the drum 2 that is devoid of cable 6.

The means 12, 16 for holding the cable 6 inside the groove 11 of the drum 2 further comprise a casing 16 positioned around the drum 2 over at least part of the circumference of the drum 2.

Finally, the winch comprises an assembly 181, 182 for detecting the end of the winding run of the cable 6 and an assembly 191, 192 for detecting the end of the unwinding run of the cable 6. Each detection assembly 181, 182; 191, 192 comprises a magnetizable metallic conductor 181, 191, such as a plate, and a sensor 182, 192, preferably inductive, for detecting the presence of said metallic conductor 181, 182. The sensor 182 or 192 and the conductor 181 or 191 can be positioned with one on a part 21 that is mounted so as to be able to move axially and fixed in rotation along a guide path 22 parallel to the axis of rotation of the drum 2, and with the other in a stationary location. The part 21 is provided with a male element 23, such as a finger, which is inserted into the groove 11 of the drum 2 to allow, in parallel with the rotational driving of the drum 2, an axial displacement of the part 21 along the guide path 22. An end of run is detected when the metallic conductor 181, 191 enters or leaves the detection field of the sensor 182, 192.

In the example shown, the sensors 182 and 192 are stationary and the conductors 181 and 191 are able to move. Obviously, the converse solution could have been envisaged without departing from the scope of the invention. The presence of these detection assemblies makes it possible to ensure that the cable is unwound and wound under good conditions despite the presence of the overrunning clutch which makes it impossible to have a position reference for the cable on the drum.

The operation of the winch as described above is therefore as follows. The operator grasps the controller, which can be borne by the cable, and chooses an operating mode.

When the first operating mode corresponding to a lifting of the load is chosen, the shaft 4 is rotated in the first direction D1 and transmits, via the reduction gear mechanism 9 and the overrunning clutch 8, its rotational movement to the drum 2, which is then driven in rotation in the direction of winding of the cable. In parallel with the winding of the cable, the cable guide 12 moves along the drum in a direction parallel to the axis of rotation of the drum, as does the conductor 181, making it possible to detect the end of the winding.

When the second operating mode corresponding to a lowering of the load is chosen, the shaft 4 is rotated in the second direction D2 and the outer part 81 of the overrunning clutch, in cooperation with the elements 83A or 83B of the overrunning clutch, limits the angular displacement of the inner part 82 of the overrunning clutch and consequently of the drum to prevent rotation of the drum, driven by the cable subjected to a tensile force resulting from the presence of a load, at a speed of rotation greater than the speed of rotation of the outer part 81 of the clutch. Once the load has been set down, the outer part 81 of the clutch can continue to rotate without affecting the inner part 82 of the clutch. The cable is therefore perfectly taut when in the set-down-load state.

In this second embodiment, in parallel with the unwinding of the cable, the cable guide moves along the drum in a direction parallel to the axis of rotation of the drum, as does the conductor 191, making it possible to detect the end of the unwinding of the cable.

1. A winch for handling a load, said winch comprising:
a drum, a cable that can be wound around the drum, means for attaching the load to the cable, a motor equipped with a drive shaft, a controller for the motor configured to selectively control the motor according to two operating modes, namely a first operating mode, in which the drive shaft of the motor is capable of being driven in rotation in a first direction, and a second operating mode, in which the drive shaft of the motor is capable of being driven in rotation in a second direction opposite to the first direction, and mechanical means for transmitting the rotational movement of the drive shaft to the drum, the mechanical movement transmission means arranged between the drive shaft and the drum being configured to allow, in the first operating mode, termed load lifting, when the drive shaft is driven in rotation in the first direction, the transmission of the rotational movement of the drive shaft to the drum in order to drive said drum in rotation so as to wind the cable around the drum,
wherein, in the second operating mode, termed load lowering, when the drive shaft is driven in rotation in the second direction, the mechanical movement transmission means are configured so as not to allow the transmission of the rotational movement of the drive shaft to the drum, at least part of the mechanical movement transmission means being configured to form, in this second operating mode, a brake on the rotational driving of the drum, limiting or preventing the rotational driving of the drum in the direction of unwinding of the cable from the drum under the action of a tensile force exerted on the cable, in particular by a load suspended from said cable.

2. The winch as claimed in claim 1, wherein the mechanical movement transmission means comprise an overrunning clutch, chosen from the group consisting of ratchet-, cam-, ball- or roller-type overrunning clutches, this clutch being interposed between the drive shaft and the drum.

3. The winch as claimed in claim 2, wherein the overrunning clutch comprises two rotating coaxial parts, one referred to as the outer, the other as the inner, and elements such as rollers, balls, cams, or pawls arranged in a space left free between said parts, said parts being mounted such that one rotates as one with the drive shaft and the other rotates as one with the drum, and the elements being loaded individually by a spring, the part that rotates as one with the drive shaft forming, in cooperation with the elements when said part rotating as one with the drive shaft is stationary, or in the second operating mode, when said part that rotates as one with the drive shaft is driven in rotation in the second direction, a means for limiting the angular displacement of the part that rotates as one with the drum which can be driven in rotation under the action of a tensile force exerted on the cable in the direction of unwinding of the cable from the drum and, in the first operating mode, when the drive shaft is driven in rotation in the first direction, a driving member for driving in rotation the part secured to the drum.

4. The winch as claimed in claim 3, the part that rotates as one with the drum forms the inner part of the overrunning clutch, this part that rotates as one with the drum being mounted on an axial extension of the drum.

5. The winch as claimed in claim 3, the part that rotates as one with the drive shaft is coupled to the drive shaft by a reduction gear mechanism.

6. The winch as claimed in claim 1, wherein the drum is mounted so as to be able to move between a so-called maximum winding position, of the cable around the drum, and a so-called minimum winding position, also termed the position of the cable being unwound from the drum, and in that the winch comprises means for returning the drum that are configured to allow a return force to be exerted on the drum, in a direction corresponding to the drum being driven in rotation in the direction of a winding of the cable around the drum.

7. The winch as claimed in claim 6, wherein the return means are configured to allow an adjustable return force to be exerted.

8. The winch as claimed in claim 6, wherein at least part of the controller for the motor is borne by the cable, and in that the return force of the return means is between the value of the force required to return the drum to the position of maximum winding of the cable around the drum in the bare state of the cable, that is to say devoid of controller for the motor, and the value of the force required to allow the drum to be driven in rotation in the direction of winding of the cable around the drum when at least a part of the controller for the motor is borne by the cable.

9. The winch as claimed in claim 1, wherein the drum is a grooved drum provided with an outer peripheral helical groove, and in that the winch comprises means for holding the cable inside the groove, these holding means comprising a cable guide provided with a passage for the cable, this cable guide being mounted so as to be axially movable and rotationally fixed along a guide path parallel to the axis of rotation of the drum, this cable guide being provided with a male element, such as a rib, inserted in the groove of the drum to allow, in parallel with the rotational drive of the drum, an axial displacement of the cable guide along the guide path.

10. The winch as claimed in claim 9, wherein, when the winch is in the use configuration with the axis of rotation of the drum in a horizontal position, the male element of the cable guide is arranged facing a groove part of the drum that has no cable.

11. The winch as claimed in claim 10, characterized in that wherein the means for holding the cable inside the groove of the drum further comprise a casing positioned around the drum over at least part of the circumference of the drum.

12. The winch as claimed in claim 1, wherein the winch whose drum is a grooved drum provided with an outer peripheral helical groove comprises an assembly for detecting the end of the winding run of the cable and an assembly for detecting the end of the unwinding run of the cable, each detection assembly comprising a magnetizable metallic conductor, such as a plate, and a sensor for detecting the presence of said metallic conductor, the sensor and the conductor can be positioned with one on a part mounted so as to be axially movable and fixed in rotation along a guide path parallel to the axis of rotation of the drum, this part being provided with a male element, such as a finger, inserted into the groove of the drum to allow, in parallel with the rotational driving of the drum , an axial displacement of said part along the guide path, and with the other in a stationary location, an end of run being detected when the metallic conductor enters or leaves the detection field of the sensor.
